(19) United States
(12) Patent Application Publication
(10) Pub. No.: US 2022/0382973 A1
(43) Pub. Date: Dec. 1, 2022

(54) Word Prediction Using Alternative N-gram Contexts

(71) Applicant: Microsoft Technology Licensing, LLC, Redmond, WA (US)

(72) Inventors: Michael LEVIT, San Jose, CA (US); Cem Aksoylar, San Mateo, CA (US)

(21) Appl. No.: 17/333,587

(22) Filed: May 28, 2021

(51) Int. Cl. G06F 40/216; G10L 15/26; G06N 20/00; G06F 40/226; G06F 40/279

(52) U.S. Cl. CPC G06F 40/216; G10L 15/26; G06N 20/00; G06F 40/226; G06F 40/279

(57) ABSTRACT

A computer implemented method includes receiving a natural language utterance, generating multiple alternative N-gram contexts for a evaluating a next word in the natural language utterance, selecting N-gram context candidates from the multiple alternative N-gram contexts comprising different sets of N-1 words in the natural language utterance for selecting a next word in the natural language utterance, and providing the N-gram context candidates for creating a transcript of the natural language utterance.

### BACKGROUND

Language models are used to help convert speech to text. A language model uses previously recognized words in an utterance to help suggest a potential next word or words that are likely to occur. Language models can be used in conjunction with acoustic models that receive sound and determine linguistic units (such as phones and words) that the sound represents. Suggesting potential next most likely words via the language model can aid the acoustic model where the uttered next word is not very clear, either due to environmental noise or the person uttering the word not speaking clearly.

Language models do not operate well when the speech includes duplicated words, such as “Cat in the the hat”, filler words such a “umm” and “uh” or other phenomena idiosyncratic to conversational spontaneous speech. Since language models generally work on a set number of previous words in the utterance, such duplicated, filler, or other unintended words in the set number of previous words can impede the ability of the language model to work properly. There are so many ways that a speaker can misspeak an utterance, it is not possible to train a language model to account accurately suggest next words for all utterances.

### SUMMARY

A computer implemented method includes receiving a natural language utterance, generating multiple alternative N-gram contexts for a evaluating a next word in the natural language utterance, selecting N-gram context candidates from the multiple alternative N-gram contexts comprising different sets of N-1 words in the natural language utterance for selecting a next word in the natural language utterance, and providing the N-gram context candidates for creating a transcript of the natural language utterance.

### BRIEF DESCRIPTION OF THE DRAWINGS

FIG. 1 is an example block flow diagram of a system for utilizing flexible contexts in a first pass during automated speech recognition according to an example embodiment.

FIG. 2 is an example block diagram illustrating the use of flexible contexts a second pass during automated speech recognition according to an example embodiment.

FIG. 3 is a table illustrating example flexible n-grams for an utterance according to an example embodiment.

FIG. 4 is flowchart of a computer implemented method for using multiple alternative n-grams for predicting a next word in an utterance according to an example embodiment.

FIG. 5 is a flowchart of a computer implemented method for selecting a best N-gram context according to an example embodiment.

FIG. 6 is a flowchart of a computer implemented method for selecting a best N-gram context according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

In the fields of computational linguistics and probability, an n-gram is a contiguous sequence of n items from a given sample of text or speech, also referred to as an utterance. The items can be phonemes, syllables, letters, words, or base pairs for various applications. For purposes of description, n-grams will be words, but could be any of the above items.

An N-gram language model predicts the probability of a given word following a fixed-length sequence of words in an utterance. Given a good N-gram model, one can predict p(w|h), which means: “what is the probability of seeing the word w given a history of previous words h—where the history contains n-1 words.”

Standard n-gram language modeling relies explicitly on contiguous histories referred to as a context. A traditional n-gram language model slides its context window one word at a time after each word. A wide range of natural language phenomena in spontaneous speech make such sliding windows unworkable, as speakers hesitate, make false starts, self-correct and find other ways to break the natural flow of language. For instance, in the natural language (NL) spontaneous sentence “<s> how is the . . . uh . . . the weather </s>”, the probability of “weather” may be computed in a 5-gram context that includes the previous four words occurring before the word to be predicted: “is the uh the” (the history) which is quite useless given any practical amounts of training material for the language model. “<s>” denotes the start of a sentence and “<s>” represents the end of the sentence or context.

Alternative techniques, such as n-grams with gaps, address the situation only partially by allowing one to skip one of the contiguous words in the utterance. The language model would do a better job computing the word's probability in a context of “<s> how is the”.

In an improved context expansion algorithm for an n-gram language model, a number of alternatives (“flexible”) contexts are maintained for the prediction of one or more next words in an utterance. Each of the alternative contexts may be obtained from one of the contexts from a previous time step via a finite number of available extension techniques (such as “slide-by-one”, “preserve”, “roll back”, “reset” etc.).

The n-gram probability of the next target word can be computed in several alternative contexts and only suggestions coming from one context (locally optimal search) or a few of the best contexts (globally optimal search) need to be consulted. In the latter case, a separate search pass is used to find the globally optimal sequence of contexts. In one example, the separate search pass may be performed using recursive processing to arrive at an optimal solution. Dynamic programming, for example, is commonly used in speech and language processing and is an algorithmic technique for solving an optimization problem by breaking it down into simpler subproblems and utilizing the fact that the optimal solution to the overall problem depends upon the optimal solution to its subproblems.

To evaluate the quality of each context, two methods may be used. In one method, the probability of the target word in each context is directly considered as this context's goodness or quality measure. Because this method requires knowing the nature of the target word, this method does not preserve the probabilistic nature of the search and is considered the “oracle method”.

An alternative “probabilistic method” for evaluating the quality of each context only looks at previous histories of the competing contexts to extract features from them and use those features to predict respective context quality or goodness with a classifier. The classifier may be trained to predict target word probabilities without knowing the target word itself.

The context expansion algorithm can be used in first-pass ASR by the language model to help determine probabilities for target words. Flexible contexts may also be used with n-gram language models to help determine total scores for n-best alternative transcriptions during a rescoring/reranking stage among top candidates or alternative transcriptions, referred to as a second-pass recognition.

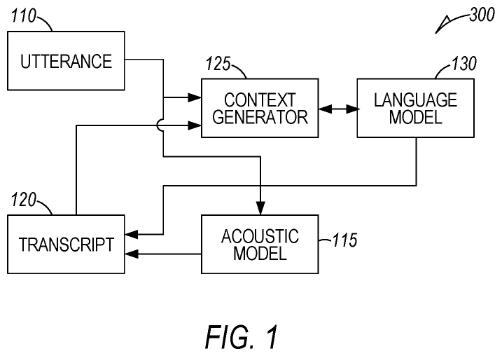

FIG. 1 is an example block flow diagram of an automated speech recognition first pass 100 for utilizing flexible contexts for evaluating continuation words in an utterance 110. The utterance may be obtained from microphones capturing speech that is digitized. The utterance may be provided to an acoustic model 115 that is used to generate a transcript 120 of the utterance 110. At the start of the utterance, there may be no context to start with. However, as the transcript is generated, a history of recognized words is obtained. These words may be provided to a context generator 125 that will then generate several different flexible contexts comprising n-grams, which include both suggested next words as well as a history of words corresponding to n-1 words of the n-gram. In one example, all known words are considered by the acoustic model 115 and the language model 130, which together will determine the continuation words having the best combined score and surviving the first pass.

The flexible contexts are provided to a language model 130 that is used to compute the probability for each possible continuation word. The probability may be referred to as a score.

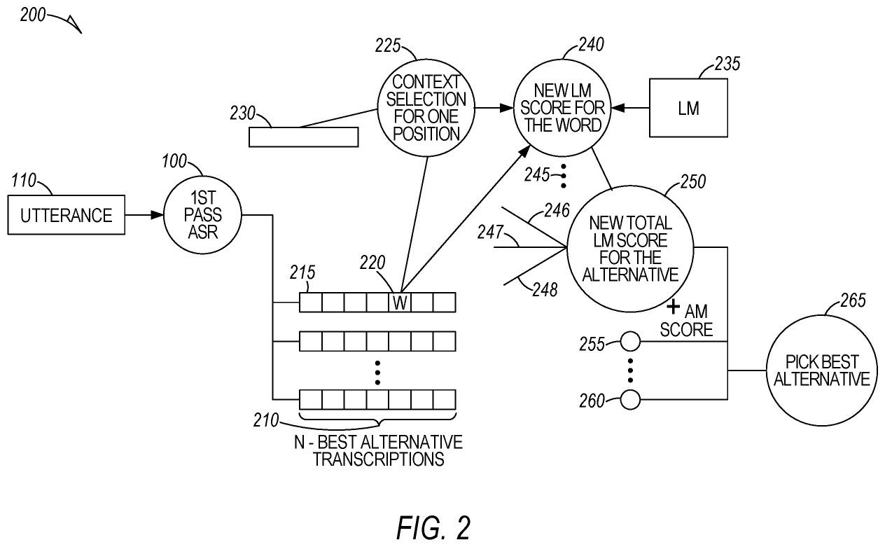

FIG. 2 is a block flow diagram of an automated speech recognition second pass 200. In the second pass, n-best alternative transcriptions 210 are considered from the first pass 100 as a function of the identified best contexts. The transcriptions 210 may be permutations of the words at each position in the utterance with the highest probabilities. Processing of a first transcription 215 will be described as an example. Processing of a word at position 220 of the transcription 215 will also be described as an example. Processing for each alternative transcription and each word in each transcription will be processed in a similar manner. FIG. 2 is a simplified illustration of second pass 200 for ease of illustration.

Context selection for one position 220 containing one word of the transcription 215 is performed to generate a context 230. Multiple different flexible contexts 230 are considered for the word with the language model (LM) 235, each generating at most one score 240. The contexts with the best scores are selected using either of the above described probabilistic mode or oracle mode.

Context selection is repeated as indicated at 245 for each word in the first transcription 215 and the scores for each (represented by lines 246, 247, 248) are generated and combined for a total score 250 for the first transcription 215. For the globally optimal implementation, this process can be embedded into a Dynamic Programming search that breaks the process into subproblems in a recursive manner then recursively finds the optimal solutions to the sub-problems. This process is repeated for each of the n-best alternative transcriptions 210 as indicated by total scores 255 through 260. The total scores for the alternative transcriptions are combined with acoustic model scores for the words in the utterance to select a best alternative transcription 265.

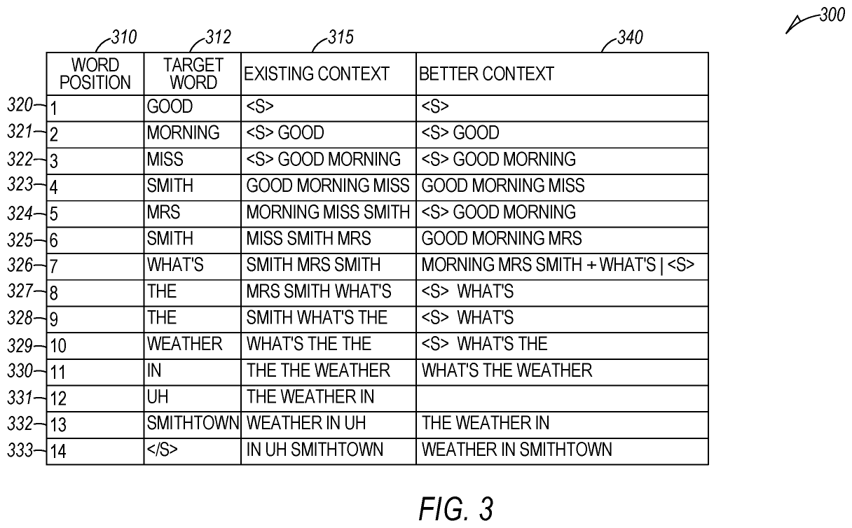

FIG. 3 is a table 300 illustrating example flexible n-grams from an utterance. FIG. 3 corresponds to a spontaneous natural language utterance: “Good morning Miss Smith . . . Mrs Smith! What's the. . . the weather in . . . uh . . . Smithtown?” A word position column 310 shows a number indicating the position of a word in the utterance. A target word is shown in column 312.

To recognize and score a transcription of this utterance, linear-chain language models will consider each word in a row and compute its probability given previous word history. For instance, in the case of lexicalized 4-gram language models, n-grams generated on a contiguous basis are shown in column 315 labeled existing context. For example, in a first row 320, corresponding to word position 1, the existing context is “good|<s>” corresponding to the first word in the utterance along with the indication of the beginning of the utterance. Progressing down rows 321, 322, 323, 324, 325, 326, 327, 328, 329, 330, 331, 332, and 333, the corresponding 4-gram contexts are illustrated.

The existing context in rows 324 through 333 indicate n-grams where the existing contexts in column 315 don't always appear to be helpful, and one could expect to do better with more intuitive contexts. What makes these contexts look suboptimal is that they are broken from the syntactic perspective. There could be several major ways in which the syntax can be considered broken, as itemized below. By imposing some permutations over the word history and by imposing these permutations in a sliding left-to-right manner, the contexts can be corrected, making them more intuitive and giving them more predictive power of the next word.

Table 300 offers some example flexible contexts in column 340 that may work better than the existing contexts, replacing proper, contiguous 4-grams in column 315 with 4-grams obtained by removing irrelevant parts from possibly longer histories. The 4-grams in column 340 provide better contexts than those in column 315.

Various methods to modify the contexts are now described. The methods provide for finding optimal contexts without iterating over all possible (n-1)-combinations of words in the entire history of the next word to be predicted, sometimes referred to as a current target word or headword. The methods find optimal contexts in an iterative manner without iterating overall such possible combinations.

In one example, a running collection of contexts is maintained as projections of the entire history on n-gram space. Every time the next headword (word to be predicted) is advanced to, the collection is updated by modifying each of its competing n-grams in a few possible ways. Each round of modifications causes a temporary explosion in the number of possible histories which may be kept under control with history recombination and by imposing various heuristic restrictions on the search space.

In other words, context generator 125 operates as a standard decoder such as a trellis decoder, that traverses the space of sentence transcriptions in a (dynamic programming) DP-manner. DP is an algorithmic technique for solving an optimization problem by breaking it down into simpler subproblems and utilizing the fact that the optimal solution to the overall problem depends upon the optimal solution to its subproblems.

In one example, a sentence may have its words represented by letters. For example, an eight-word sentence may have its words represented by the following string of letters for convenience of representation, with each letter corresponding to a word in order in the sentence: “a b cd efg h.”

As an example, assume that a 3-gram (trigram) language model is used. Assume that the probability of a headword, g, given a context of “ce”, P(g|ce), has been computed with the trigram language model. Note that for the sake of this example, the last context “ce” already lacked contiguity and did not immediately precede the headword “g”. This is normal in the decoding paradigm. The following context modification options are explored:

Advance: The Advance option is the standard n-gram context slide; the oldest word is out and the word whose probability we have just computed is in. Thus, for evaluation of the next word “h”, the context becomes “eg”. This move (and especially its version without gaps, as in ““ef”-->“fg”) is likely to be the most common for sentences without disfluencies. Examples of where this move makes sense are given in rows 320, 321, 322, and 323 of table 300.

Stay: In the Stay option, while the headword is shifting to the right, the context remains the same: therefore, the next headword “h” will be considered in context “ce”, just like the previous headword was. This move is beneficial for “stuttering” cases where the same word is repeated several times, as in row 328 of table 300.

Back-N: The Back-N option is an extension of the “Stay” move. The context is not advanced over the last headword but is actually rolled back a few steps. What exactly the new context will end up being, depends on what was traversed before “ce” in the recombined history. Thus, for the “Back-1” move, the new context could be “bc” or “ac” (depending on whether there was a gap in the past of the context “ce” or not. Of course, this means that a longer history is kept for each context (more than just n-1 words that are required for n-gram probability calculations, but this does not seem to be an issue for practical use). The length of the extra context kept determines how far back back-N can go. For instance, row 324 of table 300 would be better off with this move, as the probability of “mrs (smith)” is better computed right after “<s> good morning”.

SentenceBreak: SentenceBreak is the decision to perform an “Advance” move first, but then break the sentence and start a new one. Basically, a sentence break is hypothesized right after “g” and an additional penalty is taken in the form of P(</s>|eg), because this will be hopefully followed by a much lower probability P(h|<s>). This is what would happen in row 326 of the table 300.

Refill: In Refill, as can be seen in the previous move types, the context to modify could have one or more gaps. For its extension, it should be possible to give up on the intricacies of the past and start from scratch with a simple contiguous context of n-1 words preceding the new headword in the text. This would lead to context “fg” for the next headword “h”. For regular n-gram decoding, this move is equivalent to “Advance”.

Each of the above moves can be accompanied with a temporary unigram evaluation of the next headword without incurring any penalty in doing so. Usually, this move would result in a pay back-off penalty which involve multiplying a resulting probability by a number less than one. Because of that penalty, this option is risky and would result in unfair favoring of generally common words, even if they occur in unlikely contexts. Therefore, this option is only allowed for a few selected words that are known to be used in a more-or-less contextless manner, such as hesitations “uh”, “eh”, “umm” etc.

At any time during decoding, a situation can be encountered where several different moves can turn a given context into the same new one. In this case, preferences may be set to favor more “standard” moves (such as “Advance”) over less standard ones.

It is also possible that different histories after their respective moves would result in the same modified context. In this case, the histories will be reduced to a single alternative of highest probability. This rejection of histories is called history recombination.

Once flexible contexts have been identified, quality of the contexts is determined using either the oracle method or the probabilistic method. In the probabilistic method for flexible contexts, the decision to extend the context in certain ways is made during left-to-right decoding and only by looking at the history. Thus, if the context is being extended to evaluate the next word “h”, the decision to pick among Advance, Stay, Back-N, SentenceBreak, and Refill options (as well as to allow for possible contextless evaluation) should be done without looking at the identity of the word “h” and evaluation of its probabilities in all of the produced context alternatives.

The probability method for determining context quality utilizes a generative chain model to multiply word probabilities with context-choice probabilities and compare the resulting goodness measure with perplexity. Perplexity reflects how uncertain a model is on average every time it needs to predict a next word in a sentence given the history of the sentence. A longer history can lead to lower perplexity.

For n-best transcription rescoring, however, this rigor is not necessary. One can choose the best context by looking ahead using the oracle method and compute probabilities of the next word in all the flexible contexts. The context(s) with the largest total probability for the known next word is selected as the best context(s). In other words, computing probabilities for each context includes taking the probability of the sentence prefix along the history of the context times the probability of the next headword in the sentence.

Similarly, for the Automated Speech Recognition (ASR) decoding with a first-pass recognizer, several alternative context histories extended via several alternative moves can be simultaneously considered with the one that produces maximum-score hypothesis being selected for use.

In other words, a reasonable justification exists for the oracle mode decoding that picks the best context(s) given the identity of the word whose probability needs to be evaluated in it. As always, n-best beam decoding is used, where at each step (next headword) N best contexts with their histories are kept, making sure their total (forward) probabilities are within a certain range of the best alternative.

The following example offers an illustration to how the oracle mode navigates the search space of context extensions while following the modification options. 4-grams are used as a simple example.

Referring to table 300, probabilities of the word “smith” at position 6 have been evaluated and consideration of the next word “what's” is about to begin.

To consider the next word, it is assumed that the two best contexts in the running for “smith” in position=6 are:

C₆¹=“miss smith mrs” with P(smith|C₆¹)=P₆¹
and
C₆²=“good morning mrs” with P(smith|C₆²)=P₆²

To compute probability of the next word “what's”, each of the two contexts are extended using one of the possible five options.

From C₆¹ the following contexts are generated:

-->C₇^{1,1}=“smith mrs smith” (advance)
-->C₇^{1,2}=“miss smith mrs” (stay)
-->C₇^{1,3a}=“morning miss smith” (back-1; depending on the which history of previous selections, the first word could be not only “morning”, but also “good”, “>s>” or “</s>”)
-->C₇^{1,3b}=“good morning miss” (back-2; depending on the which history of previous selections, the first and second words could be different)

An intermediate advance step is introduced to compute P(</s>|smith miss smith) that is then extended to:

C₇^{1,4}=“<s>” (sentenceBreak)

C₇^{1,5}=“smith mrs smith” (refill; happens to be the same as advance in this case)

Neither “smith” nor “what's” are hesitation words; therefore empty context (penalty-free unigram evaluation) is not allowed in this case.

Similarly, from C₆²:

-->C₇^{2,1}=“morning mrs smith” (advance)
-->C₇^{2,2}=“good morning mrs” (stay)
C₇^{2,3a}“<s> good morning” (back-1)

no place to back-off any farther for this context

An intermediate advance step is introduced to compute P(</s>|morning mrs smith) and then extend it to

C₇^{2,4}=“<s>” (sentenceBreak)
-->C₇^{2,5}=“smith mrs smith” (refill)

Next, the probability of the next word “what's” is computed in all of these contexts and then (in the log domain) to the respective cumulative log-probabilities of the parsing histories these contexts came from.

The additional sentence-break log-probabilities of the sentenceBreak steps are also added to the affected extensions.

This produces a number of competing cumulative probabilities for step 7:

P₇^{1,1}, P₇^{1,2}, P₇^{1,3a}, P₇^{1,3b}, P₇^{1,4}, P₇^{1,5}, P₇^{2,1}, P₇^{2,2}, P₇^{2,3a}, P₇^{2,4}, P₇^{2,5}

Next, if there is more than one way to arrive at the same context in position 7, only the ones with the highest cumulative probability are kept.

For instance, C₇^{1,1}, C₇^{1,5} and C₇^{2,5} all result in “smith mrs smith”. The one whose total probability is the highest is kept.

Finally, now that parsing histories for each context have been made unique, beam-style criteria is used to pick only a few winning context alternatives for position 7.

For instance, C₇^{1,1} and C₇^{2,4} are declared to be the new starting contexts for position 7:

C₇¹ and C₇²

Then proceed to consider the word at the next position 8 as before.

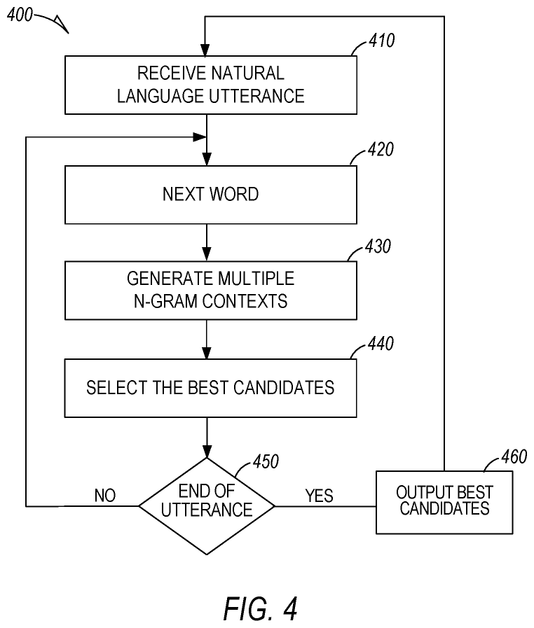

FIG. 4 is a flowchart of a computer implemented method 400 for selecting alternative n-gram contexts or extensions for use in creating a transcript such as performed by context generators 125 and 225. Method 400 may be used for both first and second pass automated speech recognition and begins at operation 410 by receiving a natural language utterance. In one example, the natural language utterance may be in the form of text generated by an acoustic model. A next word in the utterance is selected at operation 420. Multiple N-gram contexts or extensions are generated at operation 430. The multiple alternative N-gram contexts comprise different candidates that are sets of N-1 words in the natural language utterance. The best candidates are selected at operation 440. The best candidates may include the five or so best candidates selected based on their initial scores.

At operation 450 a check is made to determine if the end of the utterance has been reached. If not, the next word is selected at 420. If the end of the utterance has been reached, method 400 returns to operation 410 to receive the next natural language utterance for processing.

The multiple alternative N-gram contexts may be generated by a decoder implementing a finite number of extension techniques, such as multiple ones of an advance technique, a stay technique, a back-N technique, a sentence-break technique, and a refill slide-by-one technique.

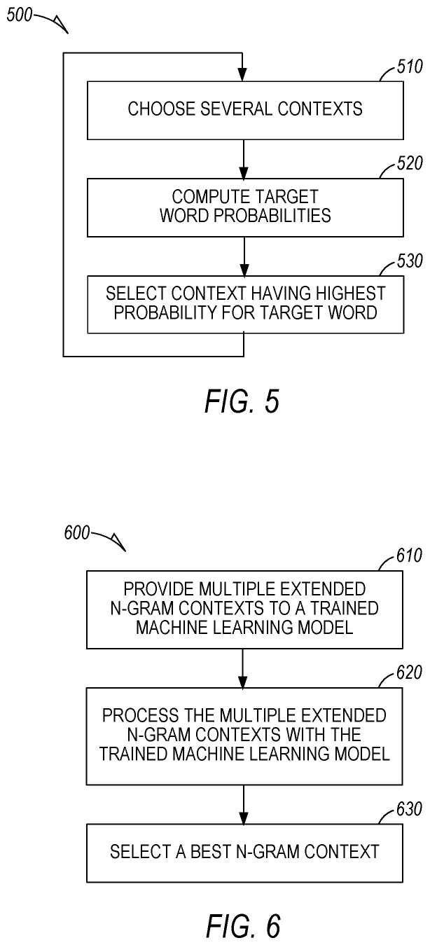

FIG. 5 is a flowchart of a computer implemented method for continued processing of method 400 to select a best N-gram context. Method 500 begins at operation 510 by selecting several contexts to process. The probabilities of the target word in each of the several contexts is computed at operation 520. Operation 530 selects the context that resulted in the highest probability. If more words remain in an utterance, method 500 is repeated for each word to select a best context for each target word. FIG. 6 is a flowchart of a computer implemented method 600 for continued processing of method 400 to select a best N-gram context utilizing the probabilistic method. Method 600 includes producing extensions for existing multiple N-gram contexts at operation 610, evaluating the next word in the natural language utterance as a function of these extended N-gram contexts at operation 620, and proceeding to evaluate a further next word with the selected N-gram context and the selected extended N-gram context.

Method 600 may continue by selecting one of the selected N-gram contexts to select the next word and the further next word at operation 630. Selecting one of the N-gram contexts to select the next word and the further next word may be done using a model trained on training data that includes extended N-gram contexts and utterance histories labeled to identify the best N-gram context.

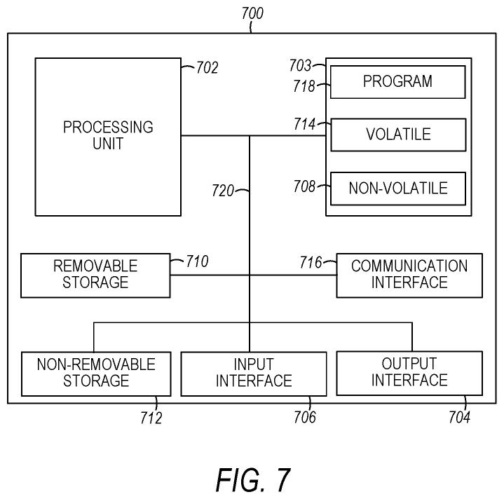

FIG. 7 is a block schematic diagram of a computer system 700 to generate flexible n-grams for use in automated speech recognition and for performing methods and algorithms according to example embodiments. All components need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include — or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 707, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### EXAMPLES

1. A computer implemented method includes receiving a natural language utterance, generating multiple alternative N-gram contexts for a evaluating a next word in the natural language utterance, selecting N-gram context candidates from the multiple alternative N-gram contexts comprising different sets of N-1 words in the natural language utterance for selecting a next word in the natural language utterance, and providing the N-gram context candidates for creating a transcript of the natural language utterance.

2. The method of claim 1 wherein the multiple alternative N-gram contexts are generated by a finite number of extension techniques.

3. The method of claim 1 wherein the multiple alternative N-gram contexts are generated by one or more of an advance technique, a stay technique, a back-N technique, a sentence-break technique, and a refill slide-by-one technique.

4. The method of claim 1 wherein evaluating the multiple N-gram contexts includes determining probabilities for the next word.

5. The method of claim 4 wherein evaluating the multiple N-gram contexts further includes providing the multiple alternative N-gram contexts to a trained machine learning model, trained on multiple alternative N-gram contexts that are labeled to identify the best N-gram context and historical words in the natural language utterance, and processing the multiple alternative N-gram contexts with the trained machine learning model to identify a best context.

6. The method of claim 1 wherein the utterance comprises multiple alternative transcriptions generated from the provided n-gram contexts, and further including generating a total score for the alternative transcriptions, and selecting a best alternative transcription based on the total score.

7. The method of claim 6 wherein generating a total score for the alternative transcriptions includes, for each alternative transcription selecting a best context for each word in each alternative transcription, generating a score for each word based on the best context, determining a total score for each of the alternative transcriptions, and selecting a best alternative transcription based on the score.

8. The method of claim 1 and further including selecting one of the multiple extended N-gram contexts, predicting the next word in the natural language utterance as a function of the selected extended N-gram context, and proceeding to predict a further next word with the selected N-gram context and the additional selected N-gram context.

9. The method of claim 8 and further comprising selecting one of the selected and extended selected N-gram contexts to select the next word and the further next word.

10. The method of claim 1 wherein the natural language utterance comprises text generated by an acoustic language model.

11. A machine-readable storage device has instructions for execution by a processor of a machine to cause the processor to perform operations to perform a method. The operations include receiving a natural language utterance, generating multiple alternative N-gram contexts for a evaluating a next word in the natural language utterance, selecting N-gram context candidates from the multiple alternative N-gram contexts comprising different sets of N-1 words in the natural language utterance for selecting a next word in the natural language utterance, and providing the N-gram context candidates for creating a transcript of the natural language utterance.

12. The device of claim 11 wherein the multiple alternative N-gram contexts are generated by one or more of an advance technique, a stay technique, a back-N technique, a sentence-break technique, and a refill slide-by-one technique.

13. The device of claim 11 wherein evaluating the multiple N-gram contexts includes determining probabilities for the next word.

14. The device of claim 13 wherein evaluating the multiple N-gram contexts further includes providing the multiple alternative N-gram contexts to a trained machine learning model, trained on multiple alternative N-gram contexts that are labeled to identify the best N-gram context and historical words in the natural language utterance, and processing the multiple alternative N-gram contexts with the trained machine learning model to identify a best context.

15. The device of claim 11 wherein the utterance comprises multiple alternative transcriptions generated from the provided n-gram contexts, and further including generating a total score for the alternative transcriptions, and selecting a best alternative transcription based on the total score.

16. The device of claim 15 wherein generating a total score for the alternative transcriptions includes, for each alternative transcription, selecting a best context for each word in each alternative transcription, generating a score for each word based on the best context, determining a total score for each of the alternative transcriptions, and selecting a best alternative transcription based on the score.

17. The device of claim 11 wherein the operations further include selecting one of the multiple extended N-gram contexts, predicting the next word in the natural language utterance as a function of the selected extended N-gram context, and proceeding to predict a further next word with the selected N-gram context and the additional selected N-gram context.

18. The device of claim 17 wherein the operations further include selecting one of the selected and extended selected N-gram contexts to select the next word and the further next word.

19. A device includes a processor and a memory device coupled to the processor and having a program stored thereon for execution by the processor to perform operations. The operations include receiving a natural language utterance, generating multiple alternative N-gram contexts for a evaluating a next word in the natural language utterance, selecting N-gram context candidates from the multiple alternative N-gram contexts comprising different sets of N-1 words in the natural language utterance for selecting a next word in the natural language utterance, and providing the N-gram context candidates for creating a transcript of the natural language utterance.

20. The device of claim 19 wherein the multiple alternative N-gram contexts are generated by one or more of an advance technique, a stay technique, a back-N technique, a sentence-break technique, and a refill slide-by-one technique.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a natural language utterance;
generating multiple alternative N-gram contexts for a evaluating a next word in the natural language utterance;
selecting N-gram context candidates from the multiple alternative N-gram contexts comprising different sets of N-1 words in the natural language utterance for selecting a next word in the natural language utterance; and
providing the N-gram context candidates for creating a transcript of the natural language utterance.

2. The method of claim 1 wherein the multiple alternative N-gram contexts are generated by a finite number of extension techniques.

3. The method of claim 1 wherein the multiple alternative N-gram contexts are generated by one or more of an advance technique, a stay technique, a back-N technique, a sentence-break technique, and a refill slide-by-one technique.

4. The method of claim 1 wherein evaluating the multiple N-gram contexts includes determining probabilities for the next word.

5. The method of claim 4 wherein evaluating the multiple N-gram contexts further comprises:
providing the multiple alternative N-gram contexts to a trained machine learning model, trained on multiple alternative N-gram contexts that are labeled to identify the best N-gram context and historical words in the natural language utterance; and
processing the multiple alternative N-gram contexts with the trained machine learning model to identify a best context.

6. The method of claim 1 wherein the utterance comprises multiple alternative transcriptions generated from the provided n-gram contexts, and further comprising:
generating a total score for the alternative transcriptions; and
selecting a best alternative transcription based on the total score.

7. The method of claim 6 wherein generating a total score for the alternative transcriptions comprises for each alternative transcription:
selecting a best context for each word in each alternative transcription;
generating a score for each word based on the best context;
determining a total score for each of the alternative transcriptions; and
selecting a best alternative transcription based on the score.

8. The method of claim 1 and further comprising:
selecting one of the multiple extended N-gram contexts;
predicting the next word in the natural language utterance as a function of the selected extended N-gram context; and
proceeding to predict a further next word with the selected N-gram context and the additional selected N-gram context.

9. The method of claim 8 and further comprising selecting one of the selected and extended selected N-gram contexts to select the next word and the further next word.

10. The method of claim 1 wherein the natural language utterance comprises text generated by an acoustic language model.

11. A machine-readable storage device having instructions for execution by a processor of a machine to cause the processor to perform operations to perform a method, the operations comprising:
receiving a natural language utterance;
generating multiple alternative N-gram contexts for a evaluating a next word in the natural language utterance;
selecting N-gram context candidates from the multiple alternative N-gram contexts comprising different sets of N-1 words in the natural language utterance for selecting a next word in the natural language utterance; and
providing the N-gram context candidates for creating a transcript of the natural language utterance.

12. The device of claim 11 wherein the multiple alternative N-gram contexts are generated by one or more of an advance technique, a stay technique, a back-N technique, a sentence-break technique, and a refill slide-by-one technique.

13. The device of claim 11 wherein evaluating the multiple N-gram contexts includes determining probabilities for the next word.

14. The device of claim 13 wherein evaluating the multiple N-gram contexts further comprises:
providing the multiple alternative N-gram contexts to a trained machine learning model, trained on multiple alternative N-gram contexts that are labeled to identify the best N-gram context and historical words in the natural language utterance; and
processing the multiple alternative N-gram contexts with the trained machine learning model to identify a best context.

15. The device of claim 11 wherein the utterance comprises multiple alternative transcriptions generated from the provided n-gram contexts, and further comprising:
generating a total score for the alternative transcriptions; and
selecting a best alternative transcription based on the total score.

16. The device of claim 15 wherein generating a total score for the alternative transcriptions comprises for each alternative transcription:
selecting a best context for each word in each alternative transcription;
generating a score for each word based on the best context;
determining a total score for each of the alternative transcriptions; and
selecting a best alternative transcription based on the score.

17. The device of claim 11 wherein the operations further comprise:
selecting one of the multiple extended N-gram contexts;
predicting the next word in the natural language utterance as a function of the selected extended N-gram context; and
proceeding to predict a further next word with the selected N-gram context and the additional selected N-gram context.

18. The device of claim 17 wherein the operations further comprise selecting one of the selected and extended selected N-gram contexts to select the next word and the further next word.

19. A device comprising:
a processor; and
a memory device coupled to the processor and having a program stored thereon for execution by the processor to perform operations comprising:
receiving a natural language utterance;
generating multiple alternative N-gram contexts for a evaluating a next word in the natural language utterance;
selecting N-gram context candidates from the multiple alternative N-gram contexts comprising different sets of N-1 words in the natural language utterance for selecting a next word in the natural language utterance; and
providing the N-gram context candidates for creating a transcript of the natural language utterance.

20. The device of claim 19 wherein the multiple alternative N-gram contexts are generated by one or more of an advance technique, a stay technique, a back-N technique, a sentence-break technique, and a refill slide-by-one technique.
